(19) United States
(12) Patent Application Publication
(10) Pub. No.: US 2026/0212589 A1
(43) Pub. Date: Jul. 23, 2026

(54) REAL-TIME RENDERING METHOD OF A THREE-DIMENSIONAL OBJECT

(71) Applicant: LUXOTTICA GROUP S.P.A., Milano (MI) (IT)

(72) Inventors: Luca MAZZOCCHI, Legnano (MI) (IT); Marco SINDONI, Bovisio Masciago (MB) (IT); Luca MORONI, Saronno (VA) (IT); Roberto RANON, Udine (UD) (IT)

(73) Assignee: LUXOTTICA GROUP S.P.A., Milano (MI) (IT)

(21) Appl. No.: 19/141,471

(22) PCT Filed: Dec. 19, 2023
(86) PCT No.: PCT/IB2023/062914

§ 371 Date: Jun. 20, 2025

(30) Foreign Application Priority Data
Dec. 22, 2022 (IT) 102022000026583

(51) Int. Cl. G06T 15/20; G06T 15/06; G06T 15/50

(52) U.S. Cl. CPC G06T 15/205; G06T 15/06; G06T 15/50; G06T 2215/16

(57) ABSTRACT

A real-time rendering method of a three-dimensional object comprising the following phases: performing the rendering of the substantially opaque elements by realizing at least one first image, performing a plurality of sequential steps, wherein the transmissive elements are rendered from the furthest to the closest to the virtual video/photo-camera according to a predetermined ordered list by realizing a respective plurality of second images, where in the first step transmissive elements furthest away from the virtual video/photo-camera are rendered using the at least one first image to determine the spectrum of the light directed towards the virtual video/photo-camera coming from the transmissive elements to be rendered, and where in each step i one or more transmissive elements are rendered using the second image obtained in the immediately preceding step to determine the spectrum of the light directed towards the virtual video/photo-camera coming from the transmissive elements to be rendered.

The present invention refers to a real-time rendering method of a three-dimensional object by employing electronic terminals such as for example smartphones, laptops, and so on.

Rendering of a three-dimensional object means the operation of representing by computer graphics a three-dimensional object placed in a virtual three-dimensional space and observed from a determined observation point, i.e., a virtual video/photo-camera.

Real-time rendering means that the above-mentioned operation of representing in computer graphics must be updated in real time following the change of the observation point, i.e., following the virtual handling of the virtual video/photo-camera in a virtual space.

In the present disclosure, reference will be made in an exemplary and non-limiting manner to the case of the glasses, the following considerations being capable of applying to the more general case of any three-dimensional object.

As is known, glasses comprise a frame coupled to lenses, where the frame comprises a front adapted to couple with and support the lenses and two temples rotatably coupled to the front through hinges so as to switch from a closed position wherein they are folded on each other to an open position which makes their use on the head of a user possible.

In the present disclosure, the three-dimensional objects will be intended as being formed by a plurality of parts such as for example the temples, the front, and the lenses of a pair of glasses, where each part will be intended as being formed by a plurality of elements, for example the metal core of a temple and the structure of the temple containing the metal core.

As is known, rendering is generally employed in different industries, from the games to the film industry, from the architecture to the more general design industry, up to the e-commerce industry and many others.

The more accurate the rendering is, the higher the degree of photorealism reached by it is.

Therefore, there is a need to graphically render as accurately as possible not only the forms, but also the features of the real materials a three-dimensional object consists of, for example the optical features of the material which have a significant impact on the degree of photorealism to be reached. Just think that a material can be, depending on its light transmission properties, substantially opaque such as a metal, or substantially transparent such as glass, or partially transparent such as a gel.

The above-mentioned optical features can also derive from the structure of the three-dimensional object; for example, a fabric, although consisting of a yarn of opaque material, can be partially transparent if the threads are not particularly dense, i.e., if it has a covering index lower than 1. Particularly, the lower the covering index is, the more transparent the fabric is.

In any case, the optical features have a remarkable impact on the graphic rendering of the three-dimensional object; for example, in the case where an object has a plurality of parts overlapping each other comprising substantially opaque elements, substantially transparent or partially transparent elements, in rendering there is a need to consider that the substantially transparent elements reveal what is behind them.

In the context of the present disclosure, the expression “substantially opaque” is intended to indicate the property of a body not to transmit the light at the visible wavelengths with an optical transmittance value close to zero in such wavelengths.

The expression “substantially transparent” is intended to indicate the property of a body to transmit the light at the visible wavelengths with an optical transmittance value close to one in such wavelengths.

The expression “partially transparent” is intended to indicate the property of a body to transmit the light at the visible wavelengths with an optical transmittance value higher than zero and lower than one in such wavelengths.

A substantially transparent or partially transparent body, as a result of the material it consists of or its structure, will be more generally referred to as transmissive; the term “transmissive” is intended to indicate the property of a body to transmit the light at the visible wavelengths.

Visible wavelengths are intended to indicate the wavelengths comprised between 350 nm and 750 nm.

The lenses can be transparent or partially transparent, therefore they are transmissive. The front and the temples can consist of the same material or different material and can be entirely or partially opaque, transparent, or partially transparent.

Depending on the position assumed by the temples and on the observation point, a transmissive front, and the lenses can reveal different elements of temples positioned behind the front with respect to the observation point; if then the elements of temples are also transmissive, they can reveal what is behind them or a core present therein.

Therefore, rendering a pair of glasses can reach different levels of complexity in light of the position assumed by the temples and of the observation point. In any case, a real-time rendering method must be capable of adapting to different complexity levels of graphic rendering.

In order to graphically represent on the computer three-dimensional objects such as the glasses having forms and materials with different light transmission capabilities, real-time rendering methods of a first type are known, which implement the following phases:
describing a three-dimensional object to be rendered by a three-dimensional mathematical model such that the reciprocal positions of the elements of the parts of the object in a virtual space are known;
performing the rendering of the substantially opaque elements obtaining a first image;
performing the rendering of the transmissive elements using the reciprocal position data contained in the above-described three-dimensional mathematical model and the image of the substantially opaque elements previously obtained to determine the spectrum of the light directed towards the virtual video/photo-camera coming from the transmissive elements to be rendered obtaining at least one second image.

In detail, in the virtual space, being known the reciprocal positioning of the elements of the parts of the three-dimensional object to be rendered, the first image is used as a boundary condition for a numerical simulation aimed at obtaining pixel by pixel the spectrum of the light received by the virtual video/photo-camera. The numerical simulation is carried out by considering a light source placed in the virtual space and calculating pixel by pixel the light received by the virtual video/photo-camera after being absorbed, reflected, and transmitted by the elements placed in the virtual space.

In an embodiment, the transmissive elements are rendered one at a time with respect to the virtual video/photo-camera obtaining a respective plurality of second images.

In such case, the rendering cannot be carried out in the correct order from the furthest transmissive element to the closest transmissive element. Therefore, the spectrum determined of the light directed towards the virtual video/photo-camera coming from the transmissive elements to be rendered can be incorrect. In such case, if in the three-dimensional object to be represented there are two or more overlaps between transmissive elements, the rendering can be inaccurate and substantially wrong.

Alternatively, the transmissive elements are rendered all together obtaining a single second image. Even in this case, if in the three-dimensional object to be represented there are two or more overlaps between transmissive elements, the rendering can be inaccurate and substantially wrong.

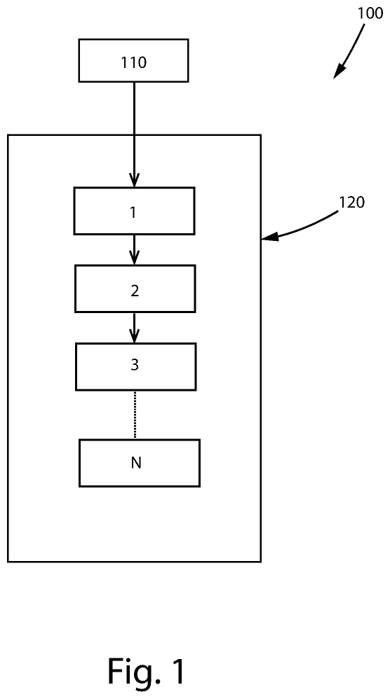

In FIG. 1, indeed, a rendering obtained by a technique of the first type is depicted, wherein behind the partially transparent lenses the substantially opaque core of a temple can be seen, but the partially transparent structure of the temple itself cannot be seen.

In order to overcome these drawbacks, rendering techniques of a second type are known, which implement the following phases:
ordering the transmissive elements from the furthest to the closest with respect to the observation point obtaining a logical order;
performing the rendering of the substantially opaque elements obtaining an image;
performing a plurality of sequential steps wherein in each step the transmissive elements are rendered from the furthest to the closest according to the logical order previously obtained by realizing at least one second image, using the image obtained in the immediately preceding step to determine the spectrum of the light directed towards the virtual video/photo-camera coming from the transmissive elements to be rendered.

Ordering the elements can be performed by different techniques presuming that the following requirements are met:
the elements must not interpenetrate each other;
the elements must be convex.

A first known ordering technique provides to calculate the distances of each element, more particularly of a reference point of each element, from the observation point. However, this ordering technique is quite rough and cannot ensure the correct ordering as it depends on the form of the elements and the position of the reference points when rendering.

Alternatively, ordering the elements can be performed by the so-called ray-casting technique which provides to trace a plurality of rays starting from the observation point towards the transmissive elements and to detect the intersections of such rays with other elements. In this way, if a ray meets in succession three transmissive elements it is determined which is the closest, the intermediate, and the furthest.

Such ordering technique is more accurate than the preceding, but its accuracy depends on the number of traced rays and the geometry of the three-dimensional object; the higher the number of the rays is, the higher the computational cost, which is already high for such technique, is. This high computational cost obstructs the application of the ray-casting technique to the real-time renderings.

An object of the present invention is to overcome the above-mentioned drawbacks and particularly to ideate a which has at the same time a high accuracy and low computational costs.

These and other objects according to the present invention are achieved by realizing a real-time rendering method of a three-dimensional object as set forth in claim 1.

Further features of the real-time rendering method of a three-dimensional object are the object of the dependent claims.

The features and advantages of a real-time rendering method of a three-dimensional object according to the present invention will be more apparent from the following exemplary and non-limiting description referred to the attached schematic drawings, wherein:

FIG. 1 is a flowchart which represents a rendering method according to the present invention;

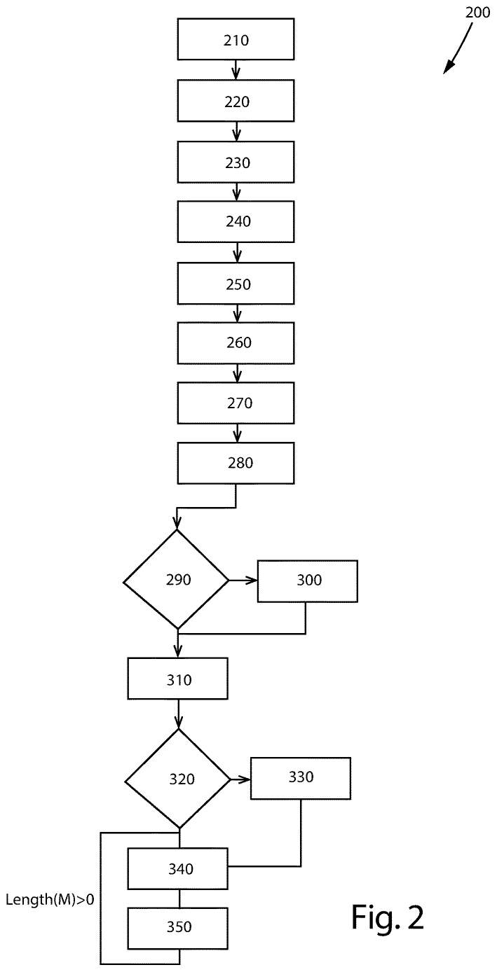

FIG. 2 is a flowchart which represents a pre-calculation procedure comprised in the rendering method according to the present invention.

With reference to the figures, a real-time rendering method of a three-dimensional object, overall denoted by 100, is shown.

Such rendering method 100 is implementable by an electronic calculator provided with a memory for data storing. Particularly, the rendering method 100 is implementable by a rendering program or software loaded in the memory of the calculator.

Therefore, such rendering program comprises instructions which induce the electronic calculator to implement the rendering method 100 when the electronic calculator executes the program.

The rendering is carried out considering the three-dimensional object as positioned in a virtual three-dimensional space XYZ and observed from a virtual observation point coincident with the position of a mobile virtual video/photo-camera. The virtual three-dimensional space XYZ for example can have an origin coincident with the centre of the minimum parallelepiped containing the three-dimensional object. In such virtual three-dimensional space XYZ the position of the virtual video/photo-camera is identified by spherical coordinates. A different pose of the three-dimensional object corresponds to each position of the virtual video/photo-camera.

The three-dimensional object comprises a plurality of parts 20 wherein each of such parts is formed by one or more elements which can be opaque or transmissive elements.

For example, the three-dimensional object is a pair of glasses comprising a frame coupled to lenses, where the frame comprises a front adapted to couple with and support the lenses and two temples rotatably coupled to the front through hinges so as to switch from a closed position wherein they are folded on each other to an open position which makes their use on the head of a user possible. The lenses, the temples, and the front are parts of the three-dimensional object.

For example, the temples comprise an at least partially transparent structure, i.e., a transmissive element and a substantially opaque metal core, i.e., an opaque element.

The rendering method 100, according to the present invention, comprises the following phases which are performed for each desired pose of the three-dimensional object:
performing 110 the rendering of the substantially opaque elements by realizing at least one first image;
performing 120 a plurality of sequential steps i with i=1, 2, . . . N wherein the transmissive elements are rendered from the furthest to the closest to the virtual video/photo-camera according to a predetermined ordered list by realizing a respective plurality of second images, where in the first step i=1 one or more transmissive elements furthest away from the virtual video/photo-camera are rendered using the at least one first image to determine the spectrum of the light directed towards the virtual video/photo-camera coming from the transmissive elements to be rendered, and where in each step i subsequent to the first one or more of said transmissive elements are rendered using the second image obtained in the immediately preceding step i−1 to determine the spectrum of the light directed towards the virtual video/photo-camera coming from the transmissive elements to be rendered.

In detail, in each step the image realized in the preceding step is used in the virtual space as a boundary condition for a numerical simulation aimed at obtaining pixel by pixel the spectrum of the light received by the virtual video/photo-camera. The numerical simulation is carried out by considering a light source placed in the virtual space and calculating pixel by pixel the light received by the virtual video/photo-camera after being absorbed, reflected, and transmitted by the elements placed in the virtual space.

Advantageously, the predetermined ordered list is selected from a plurality of pre-calculated ordered lists by a pre-calculation procedure 200, where each pre-calculated ordered list relates to a respective predetermined pose of the three-dimensional object with respect to the virtual video/photo-camera; particularly, the selected predetermined ordered list is that relative to the predetermined pose closest to the desired pose.

The predetermined pose closest to the desired pose is that having the virtual video/photo-camera placed at the minimum angular distance from the virtual video/photo-camera of the desired pose.

Therefore, the ordering of the transmissive elements is pre-calculated for a number of predetermined poses.

The rendering method considers in real time for each desired pose the pre-calculated ordered list of the transmissive elements relative to the predetermined pose closest to the desired pose.

Due to the phase of pre-calculating the predetermined ordered lists and to the approximation of the desired pose with one of the predetermined poses, the rendering method 100 according to the present invention allows the computational cost required to render a complex object with elements made of various material and parts of various structure to be reduced with respect to the prior art. Indeed, the rendering method 100 does not provide to calculate in real time the ordered lists relative to the different predetermined poses. Conversely, the rendering method 100 provides that the pre-calculation procedure 200 is performed in a moment before performing the rendering of the three-dimensional object. Therefore, performing such pre-calculation procedure 200 occurs regardless of performing the rendering method 100 and occurs in the offline mode, i.e., is not performed in real time when performing the rendering method.

Furthermore, due to the fact that in each i-th step the images realized in the preceding step are used, the rendering method 100 allows to obtain a very accurate and faithful rendering of objects with parts and elements at different light transmission capability overlapping each other.

Preferably, pre-calculating the ordered lists is performed by the pre-calculation procedure 200 assuming that the following conditions are met:
the three-dimensional object must not have elements which interpenetrate each other;
the three-dimensional object must be convex and therefore must not have concave elements.

In the case where a three-dimensional object comprises one or more concave elements, each of such concave elements is divided into a plurality of sub-elements.

Such division is carried out to attempt to obtain only convex sub-elements; however, the convexity of the sub-elements is not a constraint of the division.

Preferably, the transmissive elements which do not overlap each other are rendered in the same i-th step.

In this way, the computational cost of the rendering method 100 is even more reduced as fewer second images and therefore fewer rendering steps are provided.

Preferably, the size of the at least one first and second images when the virtual video/photo-camera moves is reduced compared to when the virtual video/photo-camera is stopped according to a reduction factor comprised between 1 and 5. Particularly, only the at least one first and second images to be used to determine the spectrum of the light directed towards the virtual video/photo-camera coming from the transmissive elements to be rendered are calculated at reduced size.

Movement of the virtual video/photo-camera means the modification by algorithms or automatic animations or by the user, for example by using a mouse or a keyboard or other interface means, of the virtual observation point not only in terms of distance, but also of angle with respect to the reference system XYZ. Visually on a monitor, handling the virtual video/photo-camera implies an enlargement/shrinking as well as a rotation of the three-dimensional object.

Preferably, the pre-calculation procedure 200 comprises the following phases which are performed for each predetermined pose:
for each transmissive element of the three-dimensional object, tracing 210 a plurality of rays starting from the virtual video/photo-camera towards a respective plurality of points of the transmissive element;
detecting 220 the intersections of each of the rays with all the elements of the three-dimensional object obtaining a first list of detected intersections;
carrying out a first filtering phase 230 wherein the repeated intersections relative to a same element, the intersections with the substantially opaque elements and the intersections with the transmissive elements which are subsequent to the intersections with the substantially opaque elements are eliminated from the first list of detected intersections, thus obtaining a second list of detected intersections;
deriving 240 from the second list of detected intersections a second list of positional relations between pairs of transmissive elements;
counting 250 the number of occurrences of the derived positional relations.

Preferably, the pre-calculation procedure 200 also comprises a second filtering phase 260 which provides the phase of:
eliminating 260 from the second list of positional relations the positional relations which have a ratio between the number of occurrences and the number of rays towards one of the elements of the respective pair lower than a predetermined threshold value obtaining a third list of positional relations.

In this way the positional relations relative to the pairs of the transmissive elements which have a low degree of reciprocal overlapping are eliminated.

For example, transmissive elements with a low degree of reciprocal overlapping are those deriving from a division of a concave original transmissive element.

Preferably, the pre-calculation procedure 200 also comprises the phases of:
inserting 270 at least one structural relation between at least two elements of the three-dimensional object;
modifying 280 the second or the possible third list of positional relations on the basis of the at least one inserted structural relation obtaining a fourth list of positional relations.

Structural relation means a specification about the reciprocal positioning of parts or elements deriving from the knowledge of the typical form of the three-dimensional object.

Preferably, in the inserting phase 270 structural relations for all the pre-calculated poses are inserted. For example, in the case where the three-dimensional object is a pair of glasses, it is known that in a top view there cannot be overlapping between the temples, the front, and the lenses, or it is known that in a side view a temple must be visible and the other must be in a back position.

This type of known positional relations are defined as structural relations and specified as positional constraints so as to facilitate the ordering between the transmissive elements 22 of the three-dimensional object.

Preferably, the pre-calculation procedure 200 also comprises the phases of:
verifying 290 if the second or the possible third or the possible fourth list of positional relations comprises one or more contradictions, i.e., one or more pairs of contradictory positional relations;
in case of a positive outcome for each contradiction, obtaining a fifth list of positional relations by performing the phases of:
if the contradiction involves a first element which is a lens and a second element, eliminating 300 from said second or said possible third or said possible fourth list of positional relations the positional relation wherein the second element is in front of the first element;
if the contradiction does not involve a lens, eliminating 310 from said second or said possible third or said possible fourth list of positional relations the positional relation which has a lower number of occurrences.

Preferably, the pre-calculation procedure 200 also comprises the phases of:
verifying 320 if the second or the possible third or the possible fourth or the possible fifth list of positional relations comprises one or more cycles;
in case of a positive outcome for each cycle, performing the phase of:
eliminating 330 the positional relation of the cycle which has a lower number of occurrences.

Preferably, the pre-calculation procedure 200 also comprises the phases of:
a) deriving 340 from the second or from the possible third or from the possible fourth or from the possible fifth list of positional relations an ordering layer formed by all the elements which are not in front of other elements;
b) eliminating 350 from the list of positional relations the positional relations which provide that the elements of the ordering layer derived in the preceding step are behind other elements;
c) repeating steps a) and b) until the length of the vector M of the list of positional relations is >0, i.e., until length(M)>0.

A pre-calculated ordered list, which is nothing but a succession of ordering layers which comprise one or more elements, is thus obtained for each predetermined pose. Preferably, the transmissive elements can be marked as belonging to a first typology or a second typology. Particularly, the transmissive elements of the first typology are capable of transmitting the light at the visible wavelengths as a result of the material they consist of. For example, transmissive elements of the first typology are the lenses or transparent or partially transparent frame portions.

The transmissive elements of the second typology are capable of transmitting the light at the visible wavelengths as a result of their structure. For example, transmissive elements of the second typology can be fabrics or general textured elements having writings or decorative patterns or however made of not continuous opaque portions which allow the light to pass by leaving gaps.

In the case where the transmissive elements are marked as described above, preferably, if an ordering layer exclusively comprises transmissive elements of the second typology, such ordering layer is cancelled and the transmissive elements of the second typology which were contained therein are put in the preceding ordering layer at the tail of the transmissive elements already present in the latter.

This reduces the number of ordering layers of the pre-calculated ordered list actually making the rendering method 100 quicker. In practice the rendering method 100 is optimized adapting to the different shapes of the three-dimensional objects to be rendered.

The features of the rendering method object of the present invention are clear from the made description, as well as the related advantages are clear.

It is clear, finally, that the rendering method thus conceived is susceptible of a number of modifications and variants, all falling within the invention; furthermore, all the details are replaceable by technically equivalent elements. In practice, the used materials, as well as the size, can be any depending on the technical requirements.

1. A real-time rendering method of a three-dimensional object having a plurality of poses with respect to a mobile virtual video/photo-camera in a virtual space XYZ, where said three-dimensional object includes a plurality of parts and each part is formed by one or more elements, said rendering method comprising, for each pose of said three-dimensional object:
performing the real-time rendering of substantially opaque elements by realizing at least one first image; and
performing a plurality of sequential steps i, with i ranging from 1 to N, wherein transmissive elements are rendered from a furthest to a closest to the mobile virtual video/photo-camera according to a predetermined ordered list realizing a respective plurality of second images, where in a first step i=1 one or more transmissive elements, furthest away from the virtual video/photo-camera, are rendered using the at least one first image to determine a spectrum of light directed towards the mobile virtual video/photo-camera coming from the transmissive elements to be rendered, and where in each step i subsequent to the first, one or more of said transmissive elements are rendered, using the second image obtained in an immediately preceding step i−1, to determine the spectrum of the light directed towards the mobile virtual video/photo-camera coming from the transmissive elements to be rendered, wherein
said predetermined ordered list being selected from a plurality of pre-calculated ordered lists by a pre-calculation procedure, where each pre-calculated ordered list relates to a respective predetermined pose of the three-dimensional object with respect to the mobile virtual video/photo-camera, said selected predetermined ordered list being that relative to the predetermined pose closest to a desired pose.

2. The real-time rendering method of the three-dimensional object according to claim 1, wherein the transmissive elements which do not overlap each other are rendered in a same step.

3. The real-time rendering method of the three-dimensional object according to claim 1, wherein the a size of the at least one first and second images, when the virtual video/photo-camera moves, is reduced compared to when the virtual video/photo-camera is stopped according to a reduction factor between 1 and 5.

4. The real-time rendering method of the three-dimensional object according to claim 1, wherein said pre-calculation procedure of said pre-calculated ordered lists is performed when any of following conditions are met:
the three-dimensional object has no elements which interpenetrate each other;
the three-dimensional object is convex and does not have concave elements; and
when said three-dimensional object includes one or more concave elements, each of such concave elements is divided into a plurality of sub-elements.

5. The real-time rendering method of the three-dimensional object according to claim 4, wherein said pre-calculation procedure includes, for each predetermined pose:
for each transmissive element of said three-dimensional object, tracing a plurality of rays starting from the mobile virtual video/photo-camera towards a respective plurality of points of said transmissive element;
detecting intersections of each of said rays with all the elements of said three-dimensional object obtaining a first list of detected intersections;
carrying out a first filtering phase by eliminating, from the first list of detected intersections, repeated intersections relative to a same element, the intersections with the substantially opaque elements and the intersections with the transmissive elements which are subsequent to the intersections with the substantially opaque elements, thus obtaining a second list of detected intersections;
deriving from the second list of detected intersections a second list of positional relations between pairs of transmissive elements; and
counting a number of occurrences of the derived positional relations.

6. The real-time rendering method of the three-dimensional object according to claim 5, wherein said pre-calculation procedure includes a second filtering phase which includes:
eliminating from the second list of positional relations the positional relations between elements which have a ratio between the number of occurrences and the number of rays towards one of the elements of the respective pair lower than a predetermined threshold value obtaining a third list of positional relations.

7. The real-time rendering method of the three-dimensional object according to claim 5, wherein the pre-calculation procedure includes:
inserting at least one structural relation between at least two elements of said three-dimensional object; and
modifying said second or said possible third list of positional relations on a basis of said at least one inserted structural relation obtaining a fourth list of positional relations.

8. The real-time rendering method of the three-dimensional object according to claim 4, wherein said pre-calculation procedure includes:
verifying whether said second or said possible third or said possible fourth list of positional relations includes one or more contradictions including one or more pairs of contradictory positional relations;
in case of a positive outcome for each contradiction, obtaining a fifth list of positional relations by implementing a procedure including:
when said contradiction involves a first element which is a lens and a second element, eliminating from said second or said possible third or said possible fourth list of positional relations the positional relation wherein the second element is in front of the first element; and
when said contradiction does not involve a lens, eliminating from said second or said possible third or said possible fourth list of positional relations the positional relation which has a lower number of occurrences.

9. The real-time rendering method of the three-dimensional object according to claim 4, wherein said pre-calculation procedure includes:
verifying whether said second or said possible third or said possible fourth or said possible fifth list of positional relations includes one or more cycles; and
in case of a positive outcome for each cycle, implementing a procedure including: eliminating the positional relation of said cycle which has a lower number of occurrences.

10. The real-time rendering method of the three-dimensional object according to claim 1, wherein said pre-calculation procedure includes:
a) deriving from said second or from the possible third or from the possible fourth or from the possible fifth list of positional relations an ordering layer formed by all the elements which are not in front of other elements;
b) eliminating from said second or from the possible third or from the possible fourth or from the possible fifth list of positional relations the positional relations which provide that the elements of said ordering layer derived in the preceding step are behind other elements; and
c) repeating a) and b) until a length of a vector M of the list of positional relations is >0 including until length(M)>0.

11. The real-time rendering method of the three-dimensional object according to claim 10, wherein the transmissive elements are marked as belonging to a first typology or a second typology and wherein when an ordering layer exclusively includes transmissive elements of the second typology, such ordering layer is cancelled and the transmissive elements of the second typology which were contained therein are put in a preceding ordering layer at a tail of the transmissive elements already present in a latter.

12. A non-transitory computer readable medium having stored thereon a computer program loadable in a memory of electronic circuitry and having instructions which induce the electronic circuitry to implement the real-time rendering method of a three-dimensional object according to claim 1, when the electronic circuitry executes the computer program.

13. The real-time rendering method of the three-dimensional object according to claim 2, wherein a size of the at least one first and second images, when the virtual video/photo-camera moves, is reduced compared to when the virtual video/photo-camera is stopped according to a reduction factor between 1 and 5.

14. The real-time rendering method of the three-dimensional object according to claim 2, wherein said pre-calculation procedure of said pre-calculated ordered lists is performed when any of following conditions are met:
the three-dimensional object has no elements which interpenetrate each other;
the three-dimensional object is convex and does not have concave elements; and
when said three-dimensional object includes one or more concave elements, each of such concave elements is divided into a plurality of sub-elements.

15. The real-time rendering method of the three-dimensional object according to claim 3, wherein said pre-calculation procedure of said pre-calculated ordered lists is performed when any of following conditions are met:
the three-dimensional object has no elements which interpenetrate each other;
the three-dimensional object is convex and does not have concave elements; and
when said three-dimensional object includes one or more concave elements, each of such concave elements is divided into a plurality of sub-elements.

16. The real-time rendering method of the three-dimensional object according to claim 6, wherein the pre-calculation procedure includes:
inserting at least one structural relation between at least two elements of said three-dimensional object; and
modifying said second or said possible third list of positional relations on a basis of said at least one inserted structural relation obtaining a fourth list of positional relations.

17. The real-time rendering method of the three-dimensional object according to claim 5, wherein said pre-calculation procedure includes:
verifying whether said second or said possible third or said possible fourth list of positional relations includes one or more contradictions including one or more pairs of contradictory positional relations;
in case of a positive outcome for each contradiction, obtaining a fifth list of positional relations by implementing a procedure including:
when said contradiction involves a first element which is a lens and a second element, eliminating from said second or said possible third or said possible fourth list of positional relations the positional relation wherein the second element is in front of the first element; and
when said contradiction does not involve a lens, eliminating from said second or said possible third or said possible fourth list of positional relations the positional relation which has a lower number of occurrences.

18. The real-time rendering method of the three-dimensional object according to claim 6, wherein said pre-calculation procedure includes:
verifying whether said second or said possible third or said possible fourth list of positional relations includes one or more contradictions including one or more pairs of contradictory positional relations;
in case of a positive outcome for each contradiction, obtaining a fifth list of positional relations by implementing a procedure including:
when said contradiction involves a first element which is a lens and a second element, eliminating from said second or said possible third or said possible fourth list of positional relations the positional relation wherein the second element is in front of the first element; and
when said contradiction does not involve a lens, eliminating from said second or said possible third or said possible fourth list of positional relations the positional relation which has a lower number of occurrences.

19. The real-time rendering method of the three-dimensional object according to claim 7, wherein said pre-calculation procedure includes:
verifying whether said second or said possible third or said possible fourth list of positional relations includes one or more contradictions including one or more pairs of contradictory positional relations;
in case of a positive outcome for each contradiction, obtaining a fifth list of positional relations by implementing a procedure including:
when said contradiction involves a first element which is a lens and a second element, eliminating from said second or said possible third or said possible fourth list of positional relations the positional relation wherein the second element is in front of the first element; and
when said contradiction does not involve a lens, eliminating from said second or said possible third or said possible fourth list of positional relations the positional relation which has a lower number of occurrences.

20. The real-time rendering method of the three-dimensional object according to claim 6, wherein said pre-calculation procedure includes:
verifying whether said second or said possible third or said possible fourth or said possible fifth list of positional relations includes one or more cycles; and
in case of a positive outcome for each cycle, implementing a procedure including: eliminating the positional relation of said cycle which has a lower number of occurrences.
